(19) United States
(12) Patent Application Publication
(10) Pub. No.: US 2017/0225951 A1
(43) Pub. Date: Aug. 10, 2017

(54) Process for Exfoliation and Dispersion of Boron Nitride

(71) Applicant: Momentive Performance Materials Inc., Waterford, NY (US)

(72) Inventors: Kristofer L. Marsh, Los Angeles, CA (US); Richard Barry Kaner, Pacific Palisades, CA (US); Anand Murugaiah, Strongsville, OH (US); Hao Qu, Westlake, OH (US)

(21) Appl. No.: 15/501,625

(22) PCT Filed: Sep. 10, 2015
(86) PCT No.: PCT/US15/49381

§ 371 Date: Feb. 3, 2017

Related U.S. Application Data
(60) Provisional application No. 62/049,015, filed on Sep. 11, 2014.

(51) Int. Cl. C01B 21/064

(52) U.S. Cl. CPC C01B 21/064; C01P 2004/24; C01P 2004/04

(57) ABSTRACT

A method for exfoliating and/or dispersing hexagonal boron nitride comprises mixing hexagonal boron nitride with a solvent system comprising at least two solvents. The use of a solvent system with at least two solvents provides improved benefits to the exfoliation process compared to the use of individual solvents.

### CROSS REFERENCE TO RELATED APPLICATIONS

The present application claims priority to and the benefit of U.S. Provisional Application No. 62/049,015 titled “PROCESS FOR EXFOLIATION AND DISPERSION OF BORON NITRIDE” filed on Sep. 11, 2014, the disclosure of which is incorporated herein by reference in its entirety.

### FIELD

The present technology provides a process for the exfoliation and dispersion of boron nitride. In particular, the present technology provides a process for exfoliating boron nitride using a solvent system comprising a plurality of solvents.

### BACKGROUND

Two-dimensional materials have significantly grown in popularity following the advent of graphene. These materials include hexagonal boron nitride (h-BN), transition metal chalcogenides, and metal halides, among many others. Particular interest has been focused toward the exfoliation of these materials into single- or few-layered (<10) atomic sheets. The nanosheet form of these materials allows access to exaggerated versions of their characteristics, such as for example high surface area, structural, electronic, and thermal properties.

Often referred to as “white graphite,” h-BN is isoelectronic with its carbon counterpart, with covalently bound interplanar B and N atoms replacing C atoms to form the sp² “honeycomb” network. Hexagonal boron nitride is known for its lack of electrical conductivity, high thermal conductivity, excellent mechanical strength, and chemical stability. Boron nitride nanosheets (BNNS) have also been confirmed to surpass the performance of their bulk counterpart in the areas of composite fillers, solid lubrication, and transistors. While being structurally analogous to graphite, traditional methods used for graphite exfoliation, such as ion intercalation, mechanical delamination, or chemical reduction (e.g. reduction of graphite oxide to form graphene), do not transfer to h-BN, despite the two having almost identical interlayer spacings (3.33-3.35 Å for graphite, vs. 3.30-3.33 Å for h-BN). The electronegativity differences between B and N atoms cause π electrons to localize around N atomic centers, and it is this polarity that causes interlayer electrostatic interactions between the partially positive B and partially negative N atoms. This results in a complex mix of multipole and dispersion interactions as well as Pauli repulsions that result in a similar interlayer distance to graphite, despite having radically different electronic properties.

Currently, the most popular routes for producing BNNS are through chemical vapor deposition (CVD) and liquid exfoliation. CVD allows for control of the growth process, and almost guarantees a low-defect, single atomic sheet of h-BN. CVD, however, is a high-temperature process that is difficult to scale up. Liquid exfoliation is a simple method to produce BNNS from bulk h-BN powder. Generally, h-BN powder is mixed with a solvent, and energy, usually ultrasonic energy, is introduced into the system. Studies have shown that h-BN disperses reasonably well in isopropyl alcohol (IPA), N,N-dimethylformamide (DMF), dimethyl sulfoxide (DMSO), and N-methylpyrrolidone (NMP). However, many of these solvents are harmful and/or dangerous to work with. Exfoliation of h-BN using water as a solvent has also been examined.

### SUMMARY

The present technology provides a process for exfoliating and dispersing boron nitride. The process employs suspending the boron nitride particles in a solvent system comprising a plurality of solvents and applying energy to the system such as by mechanical means. The present technology has been found to be particularly useful for exfoliation and increasing the efficiency of the exfoliation process to produce boron nitride nanosheets.

This system combines solvents to create a mixture that exfoliates and disperses h-BN much more efficiently than the individual components. In one embodiment, or the method of any previous embodiment, the co-solvent system is inexpensive, safe to work with, and completely scalable.

In one aspect, the technology provides a method of exfoliating and dispersing hexagonal boron nitride comprising: mixing hexagonal boron nitride with a solvent system comprising at least two solvents; and applying energy to the mixture of hexagonal boron nitride and the solvent system to provide exfoliated boron nitride particles.

In one embodiment, or the method of any previous embodiment, the at least two solvents are miscible with each other.

In one embodiment, or the method of any previous embodiment, the solvent system comprises (a) a first solvent chosen from water, an alcohol, an organic solvent, or an inorganic solvent, and (b) a second solvent chosen from water, an alcohol, an organic solvent, or an inorganic solvent, where the second solvent is different from the first solvent.

In one embodiment, or the method of any previous embodiment, at least one of the at least two solvents has a molecular weight of about 30 g/mol or greater.

In one embodiment comprising two solvents, or the method of any previous embodiment comprising two solvents, the co-solvent system has a ration of first solvent to second solvent of from about 5:95, 10:90, 20:80; 30:70: 40: 60: 45:55; or 50:50. In one embodiment or the method of any embodiment comprising two solvents, the ratio of first solvent to second solvent is from about 5:95 to about 95:5; about 10:90 to about 90:10; about 20:80 to about 80:20; about 30:70 to about 70:30; about 40:60 to about 60:40; or about 45:55 to about 55:45.

In one embodiment, or the method of any previous embodiment, the solvent system comprises a mixture of water and an alcohol. In one embodiment, the alcohol is chosen from a saturated or unsaturated C₁-C₂₀ alcohol or an isomer thereof. In one embodiment, the alcohol is chosen from methanol, ethanol, propanol, 1-propanol, 2-propanol, isopropanol, butanol, 1-butanol, 2-butanol, tert-butanol, pentanol, hexanol, heptanol, octanol, or a combination of two or more thereof.

In one embodiment, or the method of any previous embodiment, the solvent system has a w/w ratio of water to alcohol of from about 5:95 to about 95:5; from about 40:60 to about 60:40; or about 50:50.

In one embodiment, or the method of any previous embodiment, the solvent is at a temperature of from about −50° C. to about 250° C.

In one embodiment, or the method of any previous embodiment, the method comprises subjecting the mixture to centrifugation to provide (a) a solution comprising the exfoliated boron nitride material, and (b) a solid boron nitride product.

In one embodiment, or the method of any previous embodiment, the method comprises recovering solid boron nitride product and subjecting that product to the exfoliation process.

In one embodiment, or the method of any previous embodiment, applying energy to the mixture comprises subjecting the mixture to mechanical agitation chosen from ultrasonication, high shear mixing, acoustic mixing, high shear flow mixing, or a combination of two or more thereof.

In one embodiment, or the method of any previous embodiment, the hexagonal boron nitride is pre-treated or functionalized with a material chosen from a silane, siloxane, an organometallic compound, a hyperdispersant, a maleated oligomer, a fatty acid, a wax, an ionic surfactant, a non-ionic surfactant, a perfluorophenyl azide, or a combination of two or more thereof.

In one embodiment, or the method of any previous embodiment, the method comprises reconstituting, diluting, or mixing the exfoliated boron nitride particles disposed in the solvent system in a matrix. In one embodiment or the method of any previous embodiment, the matrix is chosen from water, an oil, a polymeric resin, or a combination of two or more thereof.

In one embodiment, or the method of any previous embodiment, the method comprises collecting the exfoliated boron nitride particles and drying the particles.

In one embodiment, or the method of any previous embodiment, the exfoliated boron nitride particles are formulated into a system chosen from a silicone resin, an epoxy resin, a thermoplastic, an elastomer, fluids including oils and other liquid medium or a combination of two or more thereof.

In one embodiment, or the method of any previous embodiment, the exfoliated boron nitride particles are treated or functionalized with a material chosen from a silane, siloxane, an organometallic compound, a hyperdispersant, a maleated oligomer, a fatty acid, a wax, an ionic surfactant, a non-ionic surfactant, a perfluorophenyl azide, or a combination of two or more thereof.

In one embodiment, or the method of any previous embodiment, the exfoliated boron nitride particles are formulated into a system chosen from a silicone resin, an epoxy resin, a thermoplastic, an elastomer, fluids including oils and other liquid medium or a combination of two or more thereof.

In one embodiment, or the method of any previous embodiment, the exfoliated boron nitride particles are mixed with a ceramic powder, an inorganic material, a metal powder, a non-metallic powder, an organic material, or a combination of two or more thereof.

In one embodiment, or the method of any previous embodiment, the materials are formulated into a system chosen from a silicone resin, an epoxy resin, a thermoplastic, an elastomer, fluids including oils and other liquid medium or a combination of two or more thereof.

In one embodiment, or the method of any previous embodiment, the materials are treated or functionalized with a material chosen from a silane, siloxane, an organometallic compound, a hyperdispersant, a maleated oligomer, a fatty acid, a wax, an ionic surfactant, a non-ionic surfactant, a perfluorophenyl azide, or a combination of two or more thereof. In one embodiment, or the method of any previous embodiment, the materials are formulated into a system chosen from a silicone resin, an epoxy resin, a thermoplastic, an elastomer, fluids including oils and other liquid medium or a combination of two or more thereof.

In another aspect, the present technology provides boron nitride nanosheets obtained from the methods for exfoliating or dispersing boron nitride, wherein at least some of the nanosheets exhibit folding of the nanosheets crystal structure onto itself.

In still another aspect, the technology provides a composition comprising exfoliated boron nitride obtained from the methods for exfoliating or dispersing boron nitride.

### BRIEF DESCRIPTION OF THE DRAWINGS

FIG. 1 and FIGS. 1(a)-1(f) show UV-vis data for boron nitride nanosheets obtained via a method in accordance with aspects of the present technology;

FIG. 2 is a graph comparing maximum absorbance and molecular weight for the different solvent systems used in examples of the method of the present technology;

FIG. 3 is a TEM micrograph of boron nitride nanosheets obtained via the method of the present technology;

FIG. 4 is a TEM micrograph of a partially exfoliated boron nitride nanosheet; and

FIGS. 5-7 are TEM micrographs of boron nitride nanosheets obtained after different centrifuge speeds.

### DETAILED DESCRIPTION

The present technology provides a process for exfoliating and suspending/dispersing boron nitride. The process employs liquid exfoliation of the boron nitride using a solvent system comprising a plurality of solvents. The process using a solvent system comprising a plurality of solvents has been found to be effective at exfoliating and dispersing the boron nitride particularly compared to exfoliation and dispersing of boron nitride using a single solvent.

The process comprises suspending the boron nitride in the solvent system to form a mixture, and applying energy (e.g., in the form of mechanical means) to the mixture. The mixture is then processed to separate out large unsuspended particles, and the exfoliated boron nitride generally remains in solution (e.g., the supernatant). The suspended, exfoliated boron nitride can, in one embodiment, be extracted from the suspension by removing the solvent and drying the boron nitride to obtain the exfoliated boron nitride particles. For example, the boron nitride can be obtained by filtering and drying the boron nitride or by evaporating off the solvent system. In another embodiment, the exfoliated boron nitride material in the solvent suspension can be reconstituted, diluted, or mixed with other matrices as desired for a particular purpose or intended application.

The boron nitride employed in the process is generally chosen from boron nitride platelets, which are also referred to herein as hexagonal boron nitride (h-BN). In one embodiment, the BN platelets have an average diameter of between 0.05 and 50 microns. Average particle diameter refers to the longest linear distance from one end of the BN platelet to the other. This is typically measured by scanning electron microscopy or transmission electron microscopy, or via commercially available particle size measurement systems such as those that use dynamic laser scattering.

In one embodiment, the particles may have a thickness of no more than approximately 10 nm, more preferably between 1 and 5 nm. This is typically measured via techniques such as transmission electron microscopy (TEM), calculated indirectly by counting the number of atomic layers observed in the TEM, atomic force microscopy (AFM), etc.

The powder may be a h-BN powder having an ordered hexagonal structure. The powders may have a graphitization index anywhere from 1 to 7 (highly crystalline hexagonal h-BN), greater than 1, and even greater than 2. Here as elsewhere in the specification and claims, numerical values can be combined to form new and non-disclosed ranges.

In one embodiment, the h-BN powder can be pre-treated. The h-BN can be pre-treated in a variety of ways including, but not limited to, chemical intercalation, surface treatments, functionalization, etc. Examples of suitable materials for surface treatment or functionalization of the h-BN include, but are not limited to, silanes, siloxanes, organometallic compounds such as titanates & zirconates (e.g., Ken-react by Kenrich), aluminates, hyperdispersants (e.g., Solsperse by Lubrizol), maleated oligomers such as maleated polybutadiene resin or styrene maleic anhydride copolymer (Cray Valley), fatty acids or waxes and their derivatives, and ionic or non-ionic surfactants. Examples of suitable silanes include, but are not limited to, an alkacryloxy silane, a vinyl silane, a chloro silane, a mercapto silane, a blocked mercapto silane, or a combination of two or more thereof. In one embodiment, the thermally conductive compositions can comprise from about 1 to about 5 wt. % of a silane; from about 1.5 to about 4 wt. %; even from about 2.7 to about 3.7 wt. % of a silane.

The solvent system comprises a plurality of solvents. In one embodiment, the solvent system comprises a mixture of at least two solvents. In one embodiment, the solvent system comprises (a) a first solvent chosen from water, an alcohol, an organic solvent, or an inorganic solvent, and (b) a second solvent chosen from water, an alcohol, an organic solvent, or an inorganic solvent, where the second solvent is different from the first solvent. The solvent system can comprise any combination of the materials suitable as the first and second solvents. In one embodiment, the solvents employed in the co-solvent system are generally miscible with one another. While the second solvent is different from the first solvent, it will be appreciated that the first and second solvent can of the same type or category of solvent. For example, the first and second solvent can be chosen from an alcohol. In another embodiment, the first and second solvent each can be chosen from an organic solvent. In still another embodiment, the first and second solvent can be chosen from an inorganic solvent. The terms “first” and “second” in this instance are merely ordinals used to differentiate components of the system and does not limit the system to only two solvents.

In one embodiment, the solvent system is a co-solvent comprising two solvents. In another embodiment, the solvent system is comprised of three solvents. In another embodiment, the solvent system is comprised of more than three solvents.

In one embodiment, at least one of the solvents employed in the solvent system is a relatively high molecular weight material. In one embodiment, at least one solvent has a molecular weight of about 30 g/mol or greater; about 40 g/mol or greater; about 50 g/mol or greater; about 60 g/mol or greater; about 70 g/mol or greater; about 80 g/mol or greater, etc. In one embodiment, at least one solvent has a molecular weight of from about 30 g/mol to about 150 g/mol; from about 40 g/mol to about 125 g/mol; from about 50 g/mol to about 100 g/mol; or from about 70 g/mol to about 90 g/mol. Here as elsewhere in the specification and claims, numerical values can be combined to form new and non-disclosed ranges.

The ratio of solvents can be chosen as desired for a particular purpose or intended application. In one embodiment comprising two solvents, the co-solvent system has a ratio of first solvent to second solvent of from about 5:95, 10:90, 20:80; 30:70: 40:60: 45:55; or 50:50. In one embodiment, the ratio of first solvent to second solvent is from about 5:95 to about 95:5; about 10:90 to about 90:10; about 20:80 to about 80:20; about 30:70 to about 70:30; about 40:60 to about 60:40; or about 45:55 to about 55:45. Here as elsewhere in the specification and claims, numerical values can be combined to form new and non-disclosed ranges.

Alcohols suitable as one of the solvents are generally not limited and can be chosen from a primary alcohol, a secondary alcohol, a tertiary alcohol, or a combination of two or more thereof. In one embodiment, the alcohol is chosen from a C₁-C₂₀ alcohol. It has been found that higher molecular weight alcohols are particularly suitable for use as part of the solvent system for exfoliating and dispersing boron nitride. Examples of suitable alcohols include, but are not limited to, methanol, ethanol, propanol, 1-propanol, 2-propanol, isopropanol, butanol, 1-butanol, 2-butanol, tert-butanol, pentanol, hexanol, heptanol, octanol, etc.

Examples of suitable organic solvents include, but are not limited to, acetone, N,N-dimethylformamide (DMF), dimethyl sulfoxide (DMSO), and N-methylpyrrolidone (NMP).

Examples of suitable inorganic solvents include, but are not limited to, sodium hydroxide, potassium hydroxide, ammonium hydroxide, acids including acetic acid, phosphoric acid, hydrochloric acid, and sulfuric acid.

In one embodiment, the solvent system comprises a mixture of water and an alcohol. For example, as non-limiting examples, the co-solvent can comprise water/methanol, water/ethanol, water/propanol, water/1-propanol, water/2-propanol, water/butanol, water/tert-butanol, etc. In one embodiment, the water/alcohol ratio in the co-solvent system is about 5:95, 10:90, 20:80; 30:70: 40:60; 45:55; 50:50; 55:45; 60:40; 70:30; 80:20; 90:10; or 95:5. In one embodiment, the co-solvent comprises a water/alcohol ratio of from about 5:95 to about 95:5; about 10:90 to about 90:10; about 20:80 to about 80:20; about 30:70 to about 70:30; about 40:60 to about 60:40; even about 45:55 to about 55:45. Here as elsewhere in the specification and claims, numerical values can be combined to form new and non-disclosed ranges.

While not being bound to any particular theory, the solvent system may interact with the surface of the BN platelets such that the interfacial energy is minimized, which in turn yields a favorable liquid-surface interaction. This liquid-surface interaction may serve to decrease the attractive energy between the boron nitride platelets. This decrease in energy may help to catalyze the effect of mechanically applied exfoliation aids, such as sonication, any high-shear mixing processes, high-shear flow processes, and acoustic mixing methods on the exfoliation of the boron nitride platelets.

The solvent system may be used at temperatures varying from, for example, −50° C. to 200° C. The process may be a batch, continuous, or semi-continuous process. The resulting boron nitride platelet/co-solvent mixture suspension may be reconstituted, diluted, or mixed with other matrices that comprise individually, or a combination of water; oils; and polymeric resins that include but are not limited to silicones, epoxies, thermoplastics, elastomers, and other organic materials. Degree of suspension can be determined via UV-Vis spectrometry, wherein relative absorbances of BN/solvent mixtures are compared at a wavelength of 300 nm. Simple observation of the processed samples may also reveal useful information regarding the effectiveness of different co-solvent mixtures on the suspension of BN platelets. The boron nitride platelet/co-solvent mixture suspension may also be dried to obtain the BN in a powder form that can be reconstituted in the aforementioned systems.

The type of mechanical agitation employed in the process is not particularly limited and can be chosen as desired for a particular purpose or application. Examples of suitable mechanical agitation methods include, but are not limited to, ultrasonication, high shear mixing processes, acoustic mixing methods, high shear flow processes, etc.

Following mechanical agitation of the suspension comprising the boron nitride and the solvent system, the exfoliated h-BN nanosheets (or nanoplatelets, nanomeshes, nanoribbons) are extracted by centrifugation or filtration. The extraction can be done directly if the reaction mixture is a dispersion or with added solvents if the reaction mixture is solid at room temperature. When centrifugation is used, the supernatant is usually collected as the desired exfoliated h-BN nanosheets product. However, the remaining solid from the centrifugation could be further extracted by solvents under the same or different centrifugation speed. Centrifugation can be conducted for a sufficient period of time to effectively separate the larger particles from the suspension. Centrifugation can also be conducted at a variety of speeds. In on embodiment, centrifugation can be conducted at a speed of from about 200 rpm to about 3500 rpm; from about 500 rpm to about 3000 rpm; even from about 1000 rpm to about 2000 rpm. In one embodiment, centrifugation is conducted at 500 rpm. In one embodiment, centrifugation is conducted at 1000 rpm. In one embodiment, centrifugation is conducted at 3200 rpm. Larger boron nitride particles stay in the supernatant at lower centrifugation speeds. When filtration is used, whether the filtrate or filtered solid is collected as the desired exfoliated h-BN nanosheets product depends upon the pore size of the filter paper or membrane.

Before or after collection of the exfoliated boron nitride nanosheets, the boron nitride nanosheets suspended in the solvent system can be reconstituted, diluted, or mixed with other matrices as desired for a particular purpose or intended application. Examples of suitable matrices include, but are not limited to, water, oils, polymeric resins, etc. Examples of suitable resins include, but are not limited to silicones, epoxies, thermoplastics, elastomers, etc. Examples of suitable materials or matrices include, but are not limited to, polycarbonate, polyacrylate, polyacrylonitrile, polyester, polyamide, polystyrene (including high impact strength polystyrene), polyurethane, polyurea, polyurethaneurea, polyepoxy, poly(acrylonitrile butadiene styrene), polyimide, polyarylate, poly(arylene ether), polyethylene, polypropylene, polyp henylene sulfide, poly(vinyl ester), polyvinyl chloride, poly(vinyl alcohol), bismaleimide polymer, polyanhydride, liquid crystalline polymer, cellulose polymer, or any combination thereof.

In one embodiment, the exfoliated boron nitride particles can be mixed with other materials as desired for a particular purpose or intended application. The exfoliated boron nitride particles can be mixed, for example with ceramic powders, inorganic materials, metal powders, non-metallic powders, organic materials, etc. The exfoliated boron nitride can be mixed with such materials in any suitable media or state including, for example, a powder, a paste, or a liquid. Examples of suitable materials or filler include, but are not limited to, silica, glass fibers, zinc oxide, magnesia, titania, calcium carbonate, talc, mica, wollastonite, clays, exfoliated clays, alumina, aluminum nitride, silicon carbide, silicon nitride, graphite, diamond, polymeric precursors, polymeric powders, organic materials, metallic powders, e.g., aluminum, copper, bronze, brass, etc., or a combination of two or more thereof.

The exfoliated boron nitride nanosheets or compositions comprising such materials can be utilized in a variety of compositions or applications. Compositions or articles comprising the boron nitride nanosheets can exhibit beneficial properties such as, for example, moisture barrier properties, gas barrier properties, good thermal conductivity, lubrication, non-stick, corrosion resistance, oxidation resistance, optical properties, mechanical properties, oil absorption, carrier vehicles for catalysts, polymer nucleation, neutron absorption, combinations of two or more thereof, etc. The boron nitride nanosheets obtained by the present method can be used in coatings, films, fibers, foams, molded articles, adhesives, pastes, greases, fluids, etc. Such materials can be used in a variety of applications or industries including, but not limited to, as part of or to form a heat sink structure for thermal management in a variety of applications including lighting assemblies, battery systems, sensors and electronic components, portable electronic devices such as smart phones, MP3 players, mobile phones, computers, televisions, etc. The materials can also be used as LED encapsulants.

Aspects of the technology have been described with reference to various, non-limiting embodiments. The technology can be further understood with reference to the following examples. The examples are for the purpose of illustrating aspects and embodiments of the technology and are not intended to limit the technology.

### EXAMPLES

### Examples 1-6

Chemical exfoliation of h-BN was evaluated using a solvent system comprising a mixture of an alcohol and water. Methanol (MeOH), ethanol (EtOH), 1-propanol (1-prop), 2-propanol (IPA), acetone, and tert-butanol (tBA) were chosen as the alcohol component of the solvent system. For each solvent system, solvent mixtures of alcohol/water were prepared in ratios of 90/10, 80/20, 70/30, 60/40, 50/50, 40/60, 30/70, 20/80 and 10/90 w/w % solvent in water. The process was also run with a 100% alcohol solution and a 100% water solution as controls. BNNS were prepared by way of ultrasonication. Two grades of h-BN were used: NX1, with an average particle size of 1 μm, and PT100, with an average particle size of 13 μm, both obtained from Momentive Performance Materials. NX1 was used initially for the UV-vis studies as a model material, and TEM images were taken using exfoliated PT100. Acetone, methanol, ethanol, 1-propanol, 2-propanol, and tert-butanol were obtained from Sigma-Aldrich, and all were of >99.5% purity (as purchased).

Briefly, bulk h-BN powder (average particle size of 1-13 μm, was added to a co-solvent mixture at a loading of 2 mg/mL/10 mg of h-BN and 5 mg/1 of solvent. The suspension was then sonicated for 3 hr in a B2500A-DTH bath sonicator operating at 42 kHz, rotating the sample vials every 30 minutes to ensure the most homogeneous mixing possible. Samples were then centrifuged at 3200 rpm for 20 minutes, and the supernatant was collected for analysis. Care was taken throughout all steps to ensure minimal evaporation of the solvent mixture.

Characterization of the process and the exfoliated boron nitride was evaluated using UV-vis absorbance and transmission electron microscopy (TEM). UV-vis absorbance measurements were made using a UV-3101PC UV-VIS-NIR scanning spectrophotometer (Shimadzu). The supernatant samples were pipetted into a quartz cuvette (path length 1 cm, Starna Cells, Inc.) and quickly capped. The samples were analyzed within 2 days of the initial sonication. All samples were analyzed from 700-300 nm, but the absorbance at 400 nm was used for measuring the relative amount of exfoliation for each co-solvent.

TEM micrographs and diffraction patterns were recorded using a Titan S/TEM (FEI) operating at 300 keV. TEM samples were prepared by placing a 400-mesh lacey formvar/carbon copper grid (Ted Pella, Inc.) onto a piece of qualitative filter paper (Whatman “4”). The supernatant sample of interest was then diluted to about 1:10 in water, shaken, and a few drops were added via a Pasteur pipet. The filter paper is necessary to help wick away the solvent as fast as possible. This helps to avoid restacking of the BNNS, ensuring an accurate representation of BNNS found in the co-solvent system.

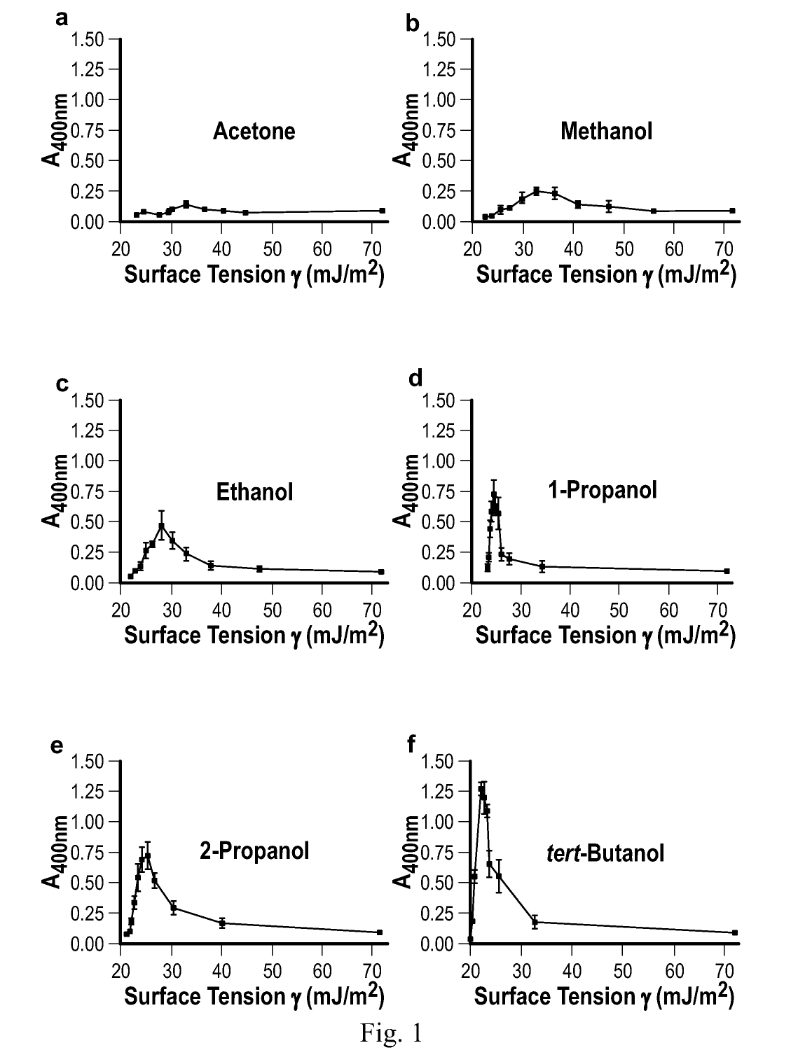

FIGS. 1(a)-1(f) show the UV-vis data collected for the different co-solvent mixtures. Because h-BN does not exhibit any prominent absorption peaks, a wavelength of 400 nm was used to compare the relative absorbances between samples. All data are the averaged results of five trials for each solvent system. The surface tension of pure water (0% w/w solvent) at standard conditions is 72.0 mJ/m²; this value decreases relative to which solvent is mixed in and at what concentration. This is represented on the X-axis in FIGS. 1 (a)-(f): the surface tension decreases from right to left corresponding to an increase in solvent w/w %. While other studies have shown evidence for both pure water and pure solvent successfully exfoliating h-BN, it is clear from the data illustrated in FIG. 1 that a mixture of solvent and water performed better than the respective liquids performed individually. The UV-vis data indicate that 60 w/w % tBA is superior at dispersing and retaining h-BN, with IPA and 1-propanol being second best (FIG. 1(f), (e), and (d), respectively). Solvent mixtures were stable after 1.5 months of sitting on the lab bench. Maximum absorbance (Amₘₐₓ) values for each solvent occur around 40-60 w/w % and increase in the following order: acetone <MeOH <EtOH <1-propanol <IPA <tBA.

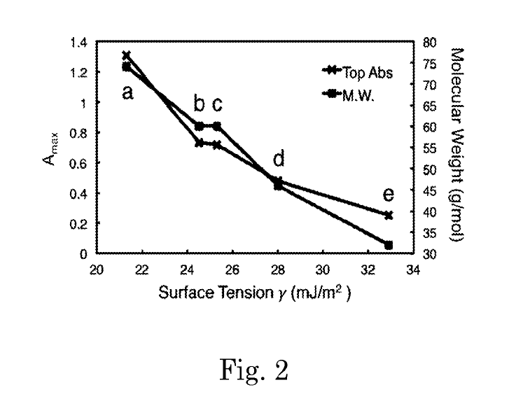

The increase in absorbance is directly proportional to increasing M.W. FIG. 2 illustrates this relationship for the solvents with similar chemical structure; tBA having the highest M.W. (74.12 g/mol) and MeOH having the lowest (32.04 g/mol). Each vertically aligned pair of data points represent: a) tBA, b) IPA, c) 1-prop, d) EtOH, and e) MeOH. The mixtures reached temperatures of 45° C. during the course of sonication. The resulting mixture was allowed to cool and was subsequently centrifuged using an Allegra X-15R centrifuge (Beckman Coulter) for 20 minutes at 3200 rpm, and the resulting supernatant was carefully extracted for further characterization. Perhaps more revealing is the relationship between M.W. and surface tension at the Aₘₐₓ for each solvent. As M.W. increases linearly with absorbance, the matching surface tension decreases. Thus, the relationship of surface tension is inversely proportional to both increasing M.W. and increasing Aₘₐₓ. Moreover, the range of surface tensions involved in Aₘₐₓ for each solvent is much wider than what the literature values suggest, with the maximums for tBA, IPA, 1-prop, EtOH, and MeOH corresponding to 21.3, 24.5, 25.3, 28, and 32.9 mJ/m², respectively. These values represent a difference of approximately 11.5 mJ/m².

Surface tension is not the only factor at play in the exfoliation of h-BN, as M.W. appears to have a great impact, even if the surface tension changes drastically. This may support the importance of considering the Lennard-Jones potential between the surface of h-BN and the solvent system, suggesting that larger solvent molecules serve to stabilize the individually dispersed sheets more effectively than smaller solvent molecules. Without being bound to any particular theory, this may be due to the larger molecules' ability to sterically separate the nanosheets, preventing their recombination in suspension. Also notable is the effect chemical structure plays on liquid exfoliation. 1-prop and IPA result in essentially identical BNNS dispersions, despite being isomers of each other.

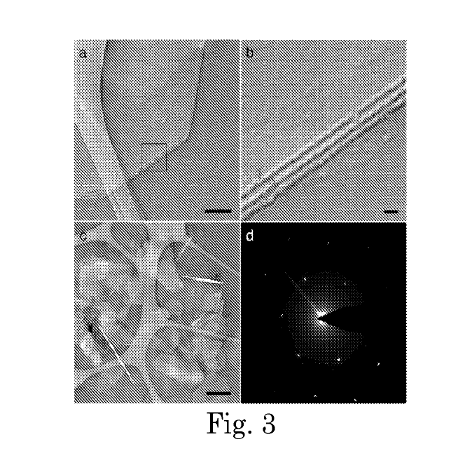

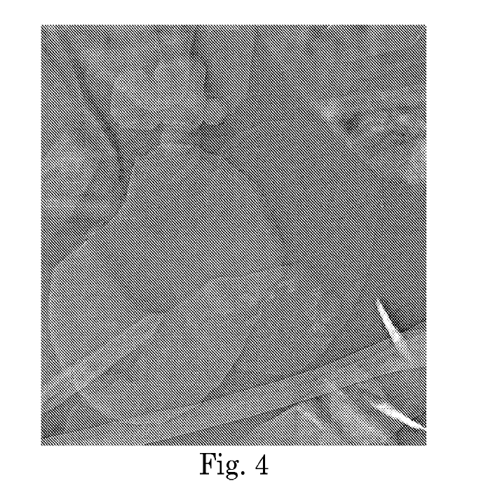

Furthermore, acetone performed the worst of all the solvents, despite having a higher M.W. (58.08 g/mol) than both MeOH and EtOH. Not to be bound to any particular theory, but this may be due to the absence of a hydroxyl group to stabilize the BNNS in the presence of water. FIG. 3 shows TEM images of BNNS after sonication. TEM is ideal for successful analysis of BNNS, as the nature of sample preparation lends itself to the resolution of atomically thin layers of material mostly avoiding restacking of the sheets. FIG. 3b (inset of FIG. 3a) reveals the thickness of a BNNS to be 3 atomic layers. FIG. 3c illustrates the scrolling effect seen in BNNS, a result of sonication and the presence of extremely thin sheets. FIG. 3c also shows the plethora of single-and few-layered sheets present on the TEM sample. FIG. 3d shows a diffraction pattern for a few-layered BNNS. FIG. 4 also shows partial exfoliation of h-BN, an intermediate step to successful exfoliation.

### Example 7

10 mg of h-BN and 5 mL of 60% w/w tert-butanol in water were added to a 3 dram vial. The vial was tightly capped and parafilmed to maintain the integrity of the solution during the sonication process. A B2500A-DTH bath sonicator (VWR) operating at 42 kHz was used for suspension and exfoliation. The vials were sonicated for 3 hours and rotated randomly around the space of the sonicator every 30 minutes to correct for any variations within the apparatus. The mixtures reached temperatures of 45° C. during the course of sonication. The resulting mixture was allowed to cool and was subsequently centrifuged using an Allegra X-15R centrifuge (Beckman Coulter) for 20 minutes at 3200 rpm, and the resulting supernatant was carefully extracted for further characterization, namely UV-Vis absorption spectroscopy (Shimadzu UV-3101PC) and transmission electron microscopy (FEI). The supernatant samples were pipetted into a quartz cuvette (path length 1 cm, Starna Cells, Inc.) and quickly capped. The samples were analyzed within 2 days of the initial sonication. All samples were analyzed from 700-300 nm, but the absorbance at 400 nm was used for measuring the relative amount of suspension/exfoliation. TEM micrographs and diffraction patterns were recorded using a Titan S/TEM (FEI) operating at 300 keV. TEM samples were prepared by placing a 400-mesh lacey formvar/carbon copper grid (Ted Pella, Inc.) onto a piece of qualitative filter paper (Whatman “4”). The supernatant sample of interest was then diluted about 1:10 in water, shaken, and a few drops were added via a Pasteur pipet. The filter paper is necessary to help wick away the solvent as fast as possible. This helps to avoid restacking of the BNNS, ensuring an accurate representation of BNNS found in the solvent system. TEM showed a representative analysis of the BN platelets, with as few as 3 layers. BN scrolls and partial exfoliation were also observed.

### Example 8

A mixture was prepared as in Example 1.A LabRAM Acoustic Mixer (Resodyn) operating at 80% power was used for suspension and exfoliation. The vial was acoustically mixed for 2 minutes at 25° C. The resulting mixture was centrifuged using an Allegra X-15R centrifuge (Beckman Coulter) for 20 minutes at 3200 rpm, and the resulting supernatant was carefully extracted for further characterization.

### Example 9

The mixture from Example 1 was combined with a 50% w/w polyvinyl alcohol in water solution, homogenized via mixing, and cast into an aluminium dish. The dish was set to heat on a hot plate at 40° C. overnight, resulting in a polymer/BN nanocomposite coupon. The coupon was then used for further analysis, including thermogravimetric analysis, stress/strain analysis, optical transmission, and thermal conductivity.

### Examples 10-12

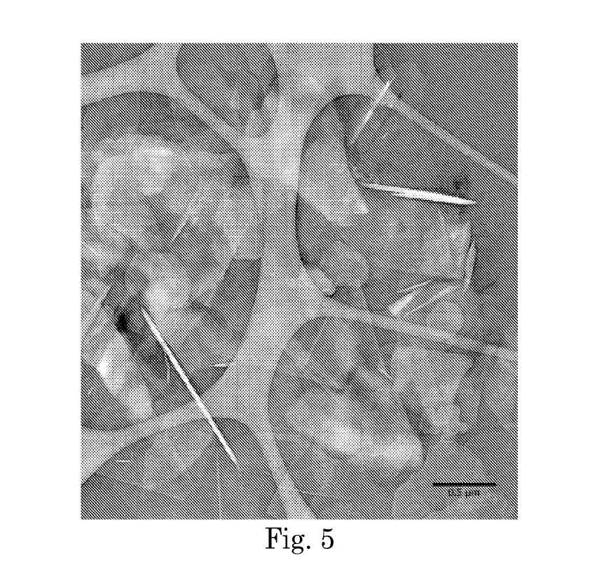

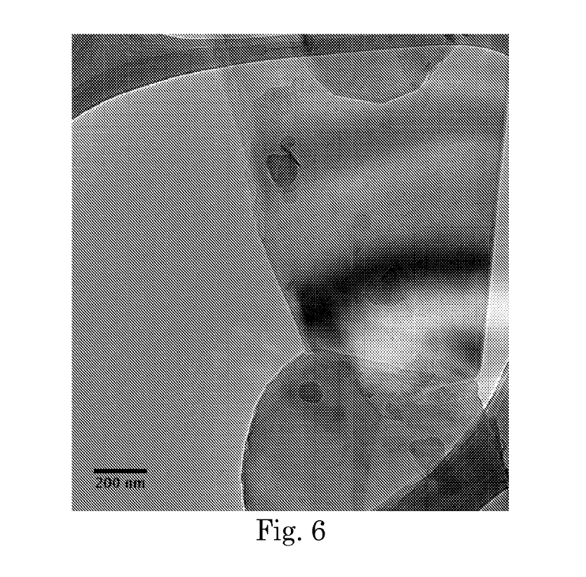

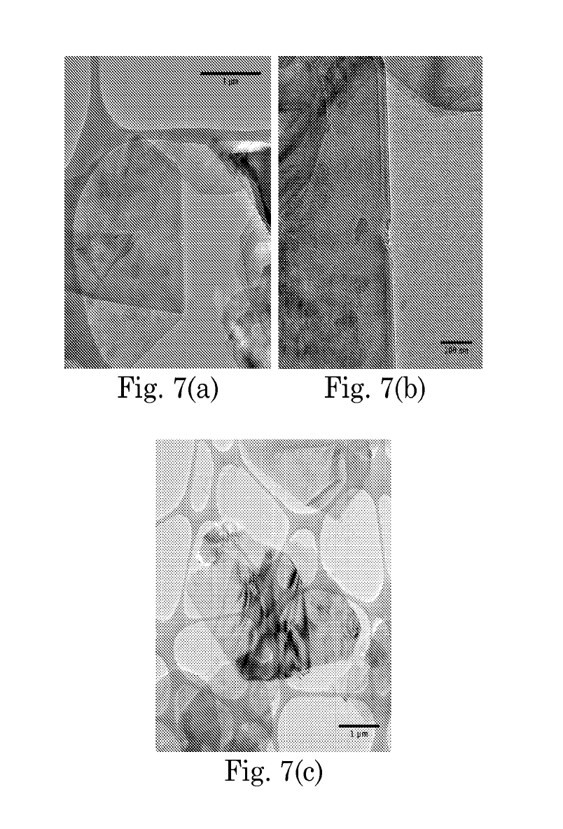

Hexagonal boron nitride was prepared as described in Example 7 except that the boron nitride was suspended in a 50% w/w water/tert-butanol solvent system. Additionally, the centrifugation speeds was varied for the different examples using speeds of 3200 rpm (Example 10), 1000 rpm (Example 11), and 500 rpm (Example 12). FIGS. 5-7 are TEM micrographs of the exfoliated boron nitride of Examples 10-12, respectively.

Embodiments of the technology have been described above with reference to various embodiments and examples, and modifications and alterations may occur to others upon the reading and understanding of this specification. The claims as follows are intended to include all modifications and alterations insofar as they come within the scope of the claims or the equivalent thereof.

1. A method of exfoliating and dispersing hexagonal boron nitride comprising:
mixing hexagonal boron nitride with a solvent system comprising at least two solvents; and
applying energy to the mixture of hexagonal boron nitride and the solvent system to provide exfoliated boron nitride particles.

2. The method of claim 1, wherein the at least two solvents are miscible with each other.

3. The method of claim 1, wherein the solvent system comprises (a) a first solvent chosen from water, an alcohol, an organic solvent, or an inorganic solvent, and (b) a second solvent chosen from water, an alcohol, an organic solvent, or an inorganic solvent, where the second solvent is different from the first solvent.

4. The method of claim 1, wherein at least one of the at least two solvents has a molecular weight of about 30 g/mol or greater.

5. The method of claim 1 wherein the solvent system comprises a mixture of water and an alcohol.

6. The method of claim 1, wherein the alcohol is chosen from a saturated or unsaturated C1-C20 alcohol.

7. The method of claim 6, wherein the alcohol is chosen from an isomer of the C1-C20 alcohol.

8. The method of claim 5, wherein the alcohol is chosen from methanol, ethanol, propanol, 1-propanol, 2-propanol, isopropanol, butanol, 1-butanol, 2-butanol, tert-butanol, pentanol, hexanol, heptanol, octanol, or a combination of two or more thereof.

9. The method of claim 5, wherein the solvent system has a w/w ratio of water to alcohol of from about 5:95 to about 95:5.

10. The method of claim 5, wherein the solvent system has a w/w ratio of water to alcohol of from about 40:60 to about 60:40.

11. The method of claim 5, wherein the solvent system has a w/w ratio of water to alcohol of about 50:50.

12. The method of claim 1, wherein the solvent is at a temperature of from about −50° C. to about 250° C.

13. The method of claim 1 comprising subjecting the mixture to centrifugation to provide (a) a solution comprising the exfoliated boron nitride material, and (b) a solid boron nitride product.

14. The method of claim 1 comprising recovering solid boron nitride product and subjecting that product to the exfoliation process.

15. The method of claim 1, wherein applying energy to the mixture comprises subjecting the mixture to mechanical agitation chosen from ultrasonication, high shear mixing, acoustic mixing, high shear flow mixing, or a combination of two or more thereof.

16. The method of claim 1, wherein the hexagonal boron nitride is pre-treated or functionalized with a material chosen from a silane, siloxane, an organometallic compound, a hyperdispersant, a maleated oligomer, a fatty acid, a wax, an ionic surfactant, a non-ionic surfactant, a perfluorophenyl azide, or a combination of two or more thereof.

17. The method of claim 1 comprising reconstituting, diluting, or mixing the exfoliated boron nitride particles disposed in the solvent system in a matrix.

18. The method of claim 17, wherein the matrix is chosen from water, an oil, a polymeric resin, or a combination of two or more thereof.

19. The method of claim 1, comprising collecting the exfoliated boron nitride particles and drying the particles.

20. The method of claim 19, wherein the exfoliated boron nitride particles are formulated into a system chosen from a silicone resin, an epoxy resin, a thermoplastic, an elastomer, fluids including oils and other liquid medium or a combination of two or more thereof.

21. The method of claim 19, wherein the boron nitride is treated or functionalized with a material chosen from a silane, siloxane, an organometallic compound, a hyperdispersant, a maleated oligomer, a fatty acid, a wax, an ionic surfactant, a non-ionic surfactant, a perfluorophenyl azide, or a combination of two or more thereof.

22. The method of claim 21, wherein the boron nitride are formulated into a system chosen from a silicone resin, an epoxy resin, a thermoplastic, an elastomer, fluids including oils and other liquid medium or a combination of two or more thereof.

23. The method of claim 19, wherein the exfoliated boron nitride particles are mixed with a ceramic powder, an inorganic material, a metal powder, a non-metallic powder, an organic material, or a combination of two or more thereof.

24. The method of claim 23, wherein the materials are formulated into a system chosen from a silicone resin, an epoxy resin, a thermoplastic, an elastomer, fluids including oils and other liquid medium or a combination of two or more thereof.

25. The method of claim 23, wherein the materials are treated or functionalized with a material chosen from a silane, siloxane, an organometallic compound, a hyperdispersant, a maleated oligomer, a fatty acid, a wax, an ionic surfactant, a non-ionic surfactant, a perfluorophenyl azide, or a combination of two or more thereof.

26. The method of claim 25, wherein the materials are formulated into a system chosen from a silicone resin, an epoxy resin, a thermoplastic, an elastomer, fluids including oils and other liquid medium or a combination of two or more thereof.

27. Boron nitride nanosheets obtained from the method of claim 1, wherein at least some of the nanosheets exhibit folding of the nanosheets crystal structure onto itself.

28. A composition comprising exfoliated boron nitride obtained from the method of claim 1.
